(19) United States
(12) Patent Application Publication
(10) Pub. No.: US 2008/0165467 A1
(43) Pub. Date: Jul. 10, 2008

(54) Drive circuit for an actuator and method for driving an actuator

(76) Inventors: Franz A. Bierbrauer, Schwalbach (DE); Christian Goetze, Herrenberg (DE); Roland Klein, Wurmberg (DE); Gerd Truckenbrodt, Weiden (DE); Hubert Keller, Amberg (DE); Manfred Schlierf, Amberg (DE)

Correspondence Address: FLYNN THIEL BOUTELL & TANIS, P.C., 2026 RAMBLING ROAD, KALAMAZOO, MI, 49008-1631, US

(21) Appl. No.: 11/983,220

(22) Filed: Nov. 7, 2007

(30) Foreign Application Priority Data
Nov. 8, 2006 (DE) 102006053531.6-32

(51) Int. Cl. H01H 47/00

(52) U.S. Cl. 361/160

(57) ABSTRACT

1. Drive circuit for an actuator and method for driving an actuator.

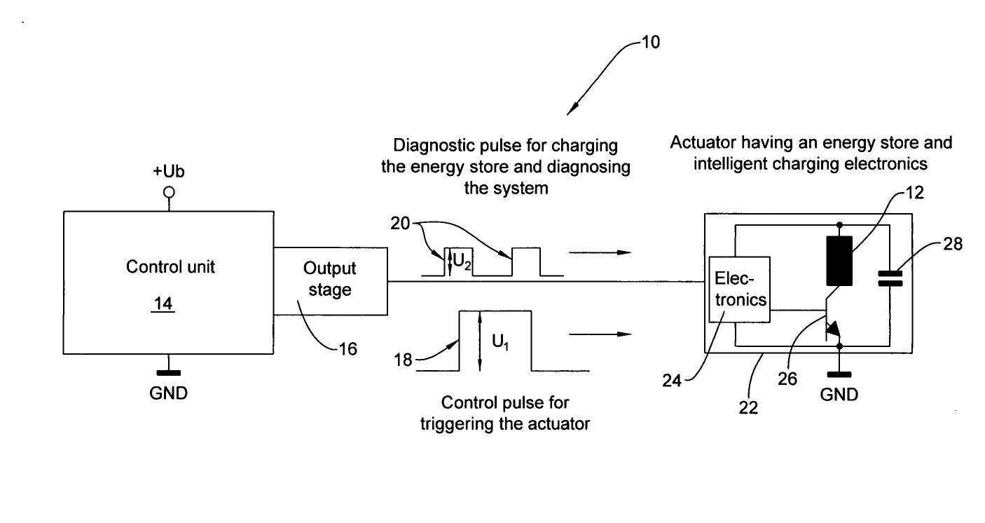

2.1. The invention relates to a drive circuit for an actuator, said drive circuit having a control unit with means for generating drive signals.
2.2. The invention provides at least one energy store and a charging unit, the charging unit having means for charging the at least one energy store using the drive signals.
2.3. Use for actuators in the automotive sector, for example.

The invention relates to a drive circuit for an actuator and to a method for driving an actuator.

In the automotive sector, in particular, only small electrical currents are often available for driving an actuator, for example the firing mechanism for an airbag or locking means for headrests, engine hoods, fuel tank covers, trunk lids, doors and the like. An identical problem is found in machine construction in the case of closing systems for CNC machining centers, security doors and the like. The actuators are usually triggered using drive signals from a control unit. However, the output power of the output stage of such control units is not sufficient to drive an actuator which is to be operated with a comparatively large electrical power. Therefore, two control units are provided for the purpose of driving an actuator. A first control unit outputs a control pulse for triggering the actuator and a second control unit essentially operates as a power stage and ensures that sufficient electrical energy is available at the actuator, by means of a second electrical line, in order to reliably trigger said actuator.

The invention is intended to provide a drive circuit for an actuator and a method for driving an actuator which can ensure that the actuator is reliably triggered with a reduced constructional outlay.

For this purpose, the invention provides a drive circuit for an actuator, said drive circuit having a control unit with means for generating drive signals, at least one energy store and a charging unit, the charging unit having means for charging the at least one energy store using the drive signals.

The invention is thus based on providing an additional energy store, for example a capacitor, and charging this energy store or retaining its charge using the drive signals from the control unit. In this case, various possibilities may be provided in order to decide whether the drive signal from the control unit is intended to be used to charge the energy store or is intended to be used to trigger the actuator. In the case of non-time-critical and non-safety-relevant applications, it may even be sufficient to use drive signals from the control unit to charge the energy store until the latter has reached an energy level that is sufficient to reliably trigger the actuator. In this case, the control unit only needs to output repeated drive signals which do not need to differ from one another.

In the case of safety-relevant applications, it is advantageous to provide at least two different types of drive signals. A first type of drive signals has, for example, a low signal voltage level which does not suffice to trigger the actuator.

However, this low signal level can be used to charge the energy store. The actuator is then triggered using a second, different drive signal which has a higher signal voltage level. Instead of different signal levels, different signal frequencies may also be used, for example.

In the case of safety-relevant applications, it is advantageous to provide evaluation electronics. Such evaluation electronics can receive the drive signals received and can decide, depending on the type of drive signals received, whether they are intended to be used to charge the energy store or are provided for the purpose of triggering the actuator.

In the automotive sector, provision may be made, for example, for the control unit to output diagnostic pulses for the purpose of diagnosing the system, in particular the actuator, and control pulses which are different to said diagnostic pulses and are intended to trigger the actuator. The diagnostic pulses and the control pulses differ in terms of the signal voltage level. The diagnostic pulses for diagnosing the actuator are used to charge an energy store, for example a capacitor, in the region of the actuator. The diagnostic pulses are voltage or current pulses which are in a so-called “no-fire” range of the actuator, that is to say represent a current or voltage pulse which is not large enough to trigger the system, that is to say the actuator. Charging electronics of the actuator can distinguish between diagnostic pulses and control pulses. The energy store is charged or its charge is retained using cyclic diagnostic pulses, for example. In order to make it possible to rapidly charge the energy store, the first diagnostic pulse(s) may be lengthened or may be effected in a shorter interval or with a higher repetition rate. After the energy store has been charged, the subsequent diagnostic pulses can then be shorter or can follow one another in a longer interval and can then be used only to retain the charge. The charging electronics or evaluation electronics can use a voltage multiplier to increase the diagnostic voltage of the diagnostic pulses and store it in the energy store. As a result, better use is made of the capacity of the energy store. If a control pulse for triggering the actuator is then present, the energy of this control pulse from the control unit and the energy of the energy store are used together to trigger the actuator.

Further features and advantages of the invention emerge from the claims and the following description of one preferred embodiment of the invention in connection with the drawing, in which

the sole FIGURE shows a diagrammatic illustration of a drive circuit according to the invention.

The sole FIGURE shows a diagrammatic illustration of a drive circuit 10 for an airbag. Airbags are fired, for example, using a firing cap which, following activation, develops compressed gases or opens a compressed air bottle, as a result of which the airbag is then inflated. A considerable amount of electrical energy is needed to activate such a firing cap and the firing cap is part of an actuator 12 which also has suitable means for converting electrical energy into thermal energy, for example, in order to fire the firing cap.

A control unit 14 is provided for the purpose of triggering the actuator 12 and has a crash sensor, for example. The control unit 14 is connected to an output stage 16 in which the output signals from the control unit are shaped. In conjunction with the output stage 16, the control unit 14 can output two different types of output signals, namely a control pulse 18 for triggering the actuator, on the one hand, and diagnostic pulses 20. The control pulse 18 has a voltage level U₁ and the diagnostic pulses have a voltage pulse U₂, U₂ being smaller than U₁. During ongoing operation, the diagnostic pulses 20 are first of all used to check the presence and functionality of the actuator 12.

The actuator 12 is also incorporated in a charging and drive circuit 22 which has intelligent charging and evaluation electronics 24, a transistor 26 and a capacitor 28. The charging and evaluation electronics 24 can distinguish between the diagnostic pulses 20 and the control pulse 18. If the control unit 14 outputs diagnostic pulses 20 in conjunction with the output stage 16, the charging and evaluation electronics 24 use these diagnostic pulses to charge the capacitor 28. For this purpose, the charging and evaluation electronics 24 contain a voltage multiplier which increases the voltage level U₂ of the diagnostic pulses so that a higher voltage than the voltage level U₂ is applied to the capacitor 28. The capacitor 28 is in the immediate vicinity of the actuator 12 in order to keep line losses as low as possible.

In order to rapidly change the capacitor 28 and thus the actuator 12 into a state in which they are ready to be triggered, the control unit 14 may emit numerous diagnostic pulses 20 in quick succession after it has been started up, for example. After the capacitor 28 has a predefined energy content, the sequence of diagnostic pulses 20 can then be reduced in order to compensate for any loss of charge at the capacitor 28.

If the crash sensor in the control unit 14 detects a vehicle impact, the control unit 14 outputs the control pulse 18 as a drive signal. The charging and evaluation electronics 24 detect the presence of a control pulse and switch it through to the transistor 26. This turns on the transistor 26, with the result that the energy stored in the capacitor 28 can flow away via the actuator 12 and the transistor 26. The energy stored in the capacitor 28 and the energy of the control pulse 18 are sufficient to fire the firing cap in the actuator 12 and to reliably inflate the airbag.

1. Drive circuit (10) for an actuator (12), said drive circuit having a control unit (14) with means for generating drive signals (18, 20), characterized by at least one energy store (28) and a charging unit (24), the charging unit (24) having means for charging the at least one energy store (28) using the drive signals (18, 20).

2. Drive circuit according to claim 1, characterized in that means are provided for applying the energy stored in the energy store to the actuator (12) on the basis of a suitable drive signal (18) from the control unit (14).

3. Drive circuit according to claim 1, characterized in that the charging unit (24) has evaluation electronics for evaluating the drive signals (18, 20) from the control unit (24) and forwards the drive signals for the purpose of triggering the actuator (12) or for the purpose of charging the energy store (28) on the basis of the evaluation result.

4. Drive circuit according to claim 3, characterized in that the means for generating drive signals from the control unit (14) can generate at least two different types of drive signals (18, 20) and the evaluation electronics of the charging unit (24) forward the drive signals either for the purpose of charging the energy store (28) or for the purpose of driving the actuator (12) on the basis of the type of drive signals.

5. Drive circuit according to claim 3, characterized in that the means for generating drive signals from the control unit (14) output control pulses for triggering the actuator (12) or diagnostic pulses, the evaluation electronics of the charging unit (24) forwarding the diagnostic pulses for the purpose of charging the energy store (28) and forwarding the control pulses for the purpose of triggering the actuator (12).

6. Method for driving an actuator (12), said method having the following steps:
at least two types of drive signals (18, 20) are generated, a first type of drive signals (18, 20) being used to charge an energy store (28) and to retain the charge of an energy store (28) and a second type of drive signals (18, 20) being used to trigger the actuator (12).

7. Method according to claim 6, characterized in that a step of evaluating the drive signals is provided and the drive signals are forwarded for the purpose of charging the energy store (28) or for the purpose of triggering the actuator (12) on the basis of the evaluation result.

8. Method according to claim 6, characterized in that, when triggering the actuator (12), the energy of the drive signals for triggering the actuator (12) and the energy stored in the energy store (28) are used together.

9. Method according to claim 6, characterized in that the drive signals (18, 20) are in the form of square wave pulses, the first type of drive signals for charging the energy store (28) having a lower signal level than the second type of drive signals.

10. Method according to claim 9, characterized in that the first type of drive signals are diagnostic pulses for determining that the actuator (12) is ready for operation.
